(19) United States
(12) Patent Application Publication
(10) Pub. No.: US 2004/0158485 A1
(43) Pub. Date: Aug. 12, 2004

(54) Information system and method for matching supply and demand on a labour market

(76) Inventor: Olaf Lawerman, Rotterdam (NL)

Correspondence Address: YOUNG & THOMPSON, 745 SOUTH 23RD STREET 2ND FLOOR, ARLINGTON, VA, 22202

(21) Appl. No.: 10/477,836

(22) PCT Filed: May 15, 2002
(86) PCT No.: PCT/NL02/00313

(30) Foreign Application Priority Data
May 16, 2001 (NL) 1018087

(51) Int. Cl. G06F 17/60

(52) U.S. Cl. 705/8

(57) ABSTRACT

An information system for matching supply and demand on a labour market comprises data storage units (20, 30) for storing thereon in electronic form information relating to potential employers. A user interface (40) enables users to consult the stored information, wherein a central processing unit (10) provides the stored information via the user interface. The information offers a multimedia presentation in respect of at least some of the employers, comprising both text information and film images. In a method for matching supply and demand on a labour market a multimedia presentation is produced of the company of a number of employers. The produced presentations are stored on data storage units and provided to potential employees via an interactive user interface.

The present invention relates to an information system and a method for matching supply and demand on a labour market.

The labour market is under great pressure in many countries. This is particularly the case in the segment of well-educated starters on the labour market and this trend will increase further under the influence of the increase in the ageing population and decrease in the young population, as diverse sources indicate. Potential employers, whether they be companies, institutions or government bodies, make great efforts to attract the attention of students, particularly those in the final stages of their studies. In this respect employers and their personnel departments are constantly searching for new and more effective ways of presenting themselves in a distinctive manner compared to their competitors on the labour market.

The career advisory centres within universities and other educational institutions are also always interested in new possibilities of communicating with the labour market, since they number among their core activities the guidance of this, the final step of a student.

On this market of labour market orientation for students there are on the one side of the spectrum relatively superficial means of orientation, such as annual directories, advertisements, job vacancy services, CD-ROMs and websites, and on the other side very intensive and expensive means of orientation such as work placements, workshops and fairs. Annual directories with company profiles have a static character and are by their very nature often not fully up to date. It is moreover not possible, or hardly so, for companies and institutions to distinguish themselves as employers from others in annual directories. In addition, there are usually large numbers of annual directories available, whereby this is a relatively expensive manner of advertising, assuming that employers will want to appear in diverse, if not all, directories.

Advertising in newspapers and magazines is if possible an even more expensive and likewise static option for allowing students to orientate themselves on the labour market. Advertising is moreover a one-off occurrence each time. This is also the case for an entry in a job vacancy service. A job-seeker who misses the advertisement or entry in question will not normally encounter it again.

All in all, none of these existing media offer the possibility of dynamic, always current and direct presentation of the company, nor do they in any respect present a cultural impression of the company or institution, while research shows that it is precisely the corporate culture which is the decisive factor in a choice of eventual employer by students.

At the other end of the spectrum of labour market orientation there are fairs, workshops and work placements, in which acquaintance is expressly made with the corporate culture. These are however particularly labour-intensive and extremely expensive ways of making a first acquaintance for both companies and for students.

A graduating student or other aspiring employee should of course make a choice in relation to the job for which he or she will ultimately apply on the basis of all the information available. For this purpose he or she will make up a short, personal “short list”. Three stages can be discerned in this process. Firstly, the information provided results in a stage also designated as “Awareness”, wherein the student at least knows the name of the company. Once the student has become familiar with the company name, specific information about the company is necessary for it to stand a chance of being included on the student's provisional “short list”. This stage involves what is designated as “Consideration” and important questions are for instance: what does the company do, what kind of people is the company looking for, what is the starter profile, what type of people work at the company and what possibilities does the company offer in the way of work placements, workshops, traineeships and career opportunities. The student will ultimately make up his or her personal “short list” of companies on the basis of his or her personal preference. These are the companies the student will actually apply to. This stage is referred to as the “Preference” of the student.

Media such as work placements, workshops and fairs do of course generate express “preference” in students, but do not result in either “awareness” or “consideration”, despite the relatively great time effort and financial investment involved therein. Less intensive media such as advertisements and annual directories are not very inspiring in either respect, and are therefore generally often not able to create “preference”. These media provide an insufficient image of the company or institution in question to achieve this.

The above outlined problem occurs not only after or during completion of a degree or school education, but also presents itself prior to such education, when the student is required to choose a course in the path toward an eventual career. When choosing an educational institution the aspiring student will also be guided in the manner indicated above and get bogged down in the no-man's land between time-intensive fairs and open days on the one hand and the superficial and often more or less dated static information from directories on the other. Within the scope of the present invention the concept of labour market and employee should therefore be interpreted in a broad sense, so as to include mutatis mutandis among others an education market respectively a student or school pupil. On the education market schools, universities and educational institutions also compete for the favour of prospective students, in order to thus secure their budget and continued existence.

The invention has for its object, among others, to provide an information system for matching supply and demand on a labour market, which allows for all three of the above stated stages in the selection process of a possible employee or prospective student.

In order to achieve the intended object an information system for matching supply and demand on a labour market comprises data storage means for storing thereon in electronic form information relating to potential employers, a user interface enabling users to consult the stored information and a central processing unit for providing the stored information via the user interface, wherein the information offers a multimedia presentation in respect of at least some of the employers, comprising both text information and film images.

The invention herewith provides a completely unique intermediate form between media which is static and frequently not very up-to-date such as annual directories and CD-ROMs on the one hand and dynamic forms of introduction such as work placements and workshops on the other. The information system according to the invention presents an integral picture of different potential employers in a uniform and consistently accessible form via the joint user interface. The system herein comprises on the one hand the information which would otherwise have been obtained from directories, CD-ROMs and other information sources of predominantly textual nature, and the invention adds thereto on the other hand a multimedia aspect in the form of film images, whereby a realistic cultural impression can be presented, so as to thus make workshops and work placements for this purpose unnecessary. The system according to the invention thus results in both ‘awareness’ and ‘consideration’ in an interested aspiring employee. The cultural impression presented by the system furthermore creates a fertile soil which can lead to ‘preference’ in the case of that same candidate. Using the information system according to the invention the job-seeker can thus go through all the stages of development needed to arrive at a personal ‘short list’. Although in terms of intensity perhaps not comparable to the impression of a company a student would have obtained during a work placement or workshop, the relatively concise cultural impressions presented by the information system according to the invention are on the other hand, both for the job-seeker and for the employers from a cost and time viewpoint, an extremely efficient form of introducing job-seekers to, and allowing them to be inspired by, the companies of the diverse employers. In a relatively short period of time the information system according to the invention hereby offers students and other job-seekers both a broader ‘awareness’ base and a broader ‘consideration’ base, and furthermore the feeling on the basis of which he or she will eventually decide to apply to the company of his or her choice.

In order to achieve the intended object, a method for matching supply and demand on a labour market, wherein information regarding the company of one or more employers is presented to one or more potential employees, is characterized in that a multimedia presentation is produced of the company of a number of employers, that the produced presentations are stored on data storage means and that potential employees are provided with access to the presentations stored on the data storage means via an interactive user interface.

The latter is particularly the case in a specific embodiment of the information system according to the invention being characterized in that the multimedia presentation comprises components from a group of an optionally filmed general company impression, an interview with or speech by a member of the board of directors, an interview with staff members of one or more different departments and levels of experience, at least outlines of at least one annual report, general company information and news reports. A particular embodiment of the method according to the invention is similarly characterized in that a general company impression is compiled, and an interview is recorded with a member of the board of directors, and with members of staff of one or more different departments and levels of experience within the company, and that the recordings and company impression are brought together in the multimedia presentation of the company. The job-seeker can thus be given a look, via diverse filmed interviews, at different parts of the company or the institution in which the candidate is interested and, in addition, can consult purely factual data found in annual reports and other general company information of mainly textual nature. The invention thus combines the ‘hard’ rational and informative side of the traditional media, such as annual directories and advertisements, with the ‘soft’ emotional and possibly inspiring character of a cultural impression on the basis of film images and different interviews, which previously could only be presented by means of orientation such as work placements, workshops and fairs, which in terms of cost and time were considerably more intensive.

In a further particular embodiment the information system according to the invention is characterized in that the data storage means arc accommodated in a joint housing at least partly together with the central processing unit and the user interface. The information system is herein integrated fully or at least to a large extent in a joint housing which can be employed as stand-alone unit. Such units are for instance placed in universities, colleges and other educational institutions in order to introduce students and school pupils to the contracted companies and institutions. The company impressions can herein optionally be geared to the nature and level of the educational institution in question. These companies and institutions can thus present a picture of themselves, which is in large measure comprehensive and up-to-date, to an almost unlimited group of students and school pupils in a particularly efficient manner, wherein in particular an impression of their own corporate culture can be presented. Nor is the use of the information system according to the invention in this form limited to educational institutions, but it can also be used in for instance employment agencies, job centers, fairs and other facilities where supply and demand on the labour market usually come together.

A particularly ergonomic assembly is provided by a further specific embodiment of the information system according to the invention which is characterized in that the user interface comprises a touch screen and that the central processing unit, loaded with a suitable program code, offers via the touch screen an interactive interface which provides access to the stored information The touch screen avoids the necessity of further input means such as a keyboard and mouse, and provides an interactive interface which can be laid out in completely fee manner, by means of which the user is for instance enabled to search the supplied information and retrieve therefrom the required data he/she requires. The touch screen herein provides the option of inputting commands and selection data by the users as well as an output medium by means of which the stored information is provided.

In a further particular embodiment the information system according to the invention has the feature that the data storage means comprise at least one exchangeable information carrier. The exchangeable storage medium herein comprises for instance a (magneto-)optical information carrier such as an optionally (re)writable disk in accordance with the CD, CD-ROM, DVD or similar standard on which a large amount of data can be stored at relatively low cost price. Exchangeable magnetic disks, solid-memory memory modules and other present-day and future information carriers are likewise applicable within the scope of this particular embodiment of the information system according to the invention. Because the information carrier can be exchanged, the system can be initialized and updated in simple manner by arranging therein or exchanging one or more information carriers, and more specifically one per company or institution, provided with the desired company information. Maintenance of the system is hereby exceptionally easy.

The data storage means are only required per se to be readable within the information system according to the invention. In a preferred embodiment however, the information system according to the invention has the feature that the data storage means comprise at least one local memory unit, in particular a hard drive station, which is writable and readable by electronic means. The locally stored information can herein be constantly supplemented and changed in order to keep it up-to-date and complete. A mix is also possible wherein static information which is not subject to change, or hardly so, is obtained from a read-only medium, while constantly changing data is stored on a writable memory medium so that this information can be continually refreshed.

A further preferred embodiment of the information system according to the invention has the feature that the central processing unit is coupled to a communication interface for communication with at least one remote computer system. The information system can be remotely controlled and managed by means of the communication interface. Updates of the available information can thus be provided among other things from the remote computer system and be downloaded into the data storage means of the system. The communication interface moreover provides the option of a fully or partly centralized storage, management and supply of the information on or via the remote computer system. A particular embodiment of the information system according to the invention has for this purpose the feature that the at least one remote computer system comprises at least a part of the data storage means.

The communication interface can couple a conventional digital or analog, modem connection from a public switched telephone network (PSTN) to the system, but can also provide an advanced and fast network connection to the remote computer system. A particular embodiment of the information system according to the invention makes use of the latter possibility and has the feature that the information system and the at least one remote computer system are mutually coupled in an information network. This enables sharing of the stored information between a number of user interfaces over a broadband network connection. An information system according to the invention has the more particular feature that the information network at least forms part of the Internet. The user interface is in this case formed by each of possibly many network clients of individual users of the Internet who can thus consult the information system according to the invention from their own workplace.

A further embodiment of the information system according to the invention has the feature that communication means are provided which enable a user to make contact with an employer of choice. In this embodiment a job-seeker can use the information system not only to become acquainted with the companies and institutions included therein, but the system also offers the further option of making direct contact and optionally even taking a subsequent step in a thus started selection procedure, such as for instance a request for information and further data or even for an appointment for an optionally exploratory talk. In this respect a further particular embodiment of the information system according to the invention is characterized in that the communication means comprise provisions for electronic message traffic. The electronic message traffic, normally designated as e-mail, can for instance be activated from the user interface and provides the possibility of making direct contact, wherein address information and the like are optionally supplied from the interface itself, and the user only has to input the desired message. The system is hereby exceptionally user-friendly and easily accessible. In order to add a personal note, a further embodiment of the information system according to the invention is characterized in that the communication means comprise provisions for transmitting a video message. In this case the return communication by the user also acquires a multimedia character by adding a video message, so that the approached employer immediately obtains a relatively complete picture of the candidate in question and can decide on the basis thereof whether or not to initiate an employment procedure.

The invention will now be further elucidated on the basis of a number of embodiments and a drawing. In the drawing.

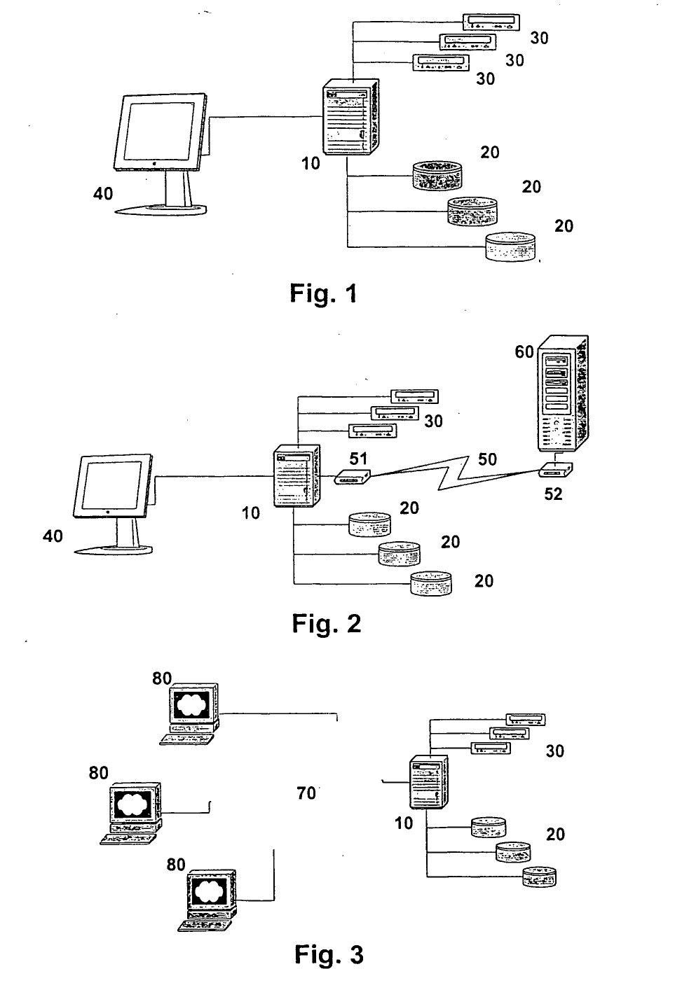

FIG. 1 shows a schematic view of a first embodiment of an information system for matching supply and demand on a labour market according to the invention;

FIG. 2 shows a schematic view of a second embodiment of an information system for matching supply and demand on a labour market according to the invention;

FIG. 3 shows a schematic view of a third embodiment of an information system for matching supply and demand on a labour market according to the invention; and

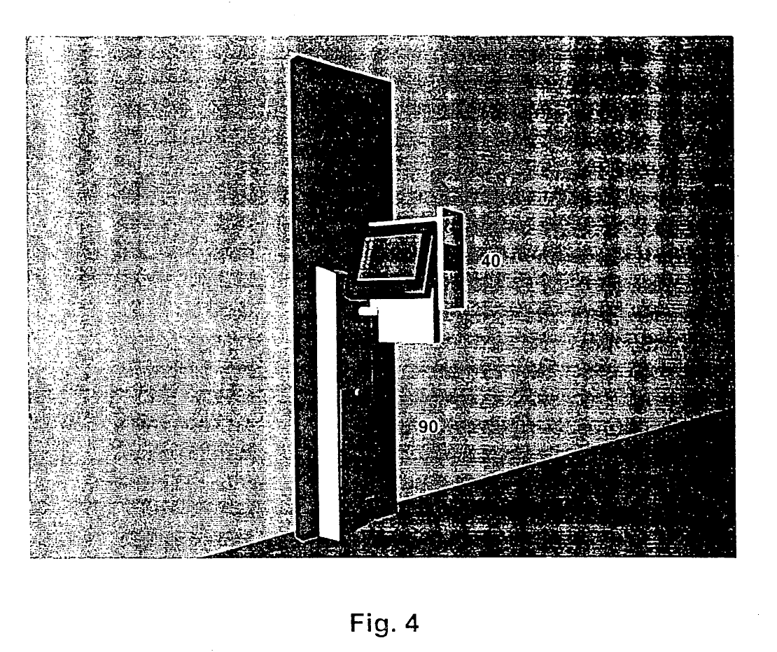

FIG. 4 shows a perspective view of a joint housing provided with an information system for matching supply and demand on a labour market according to the invention.

The figures are purely schematic and not drawn to scale. For the sake of clarity some dimensions in particular are shown (highly) exaggerated. Corresponding parts are designated as far as possible with the same reference numeral.

The information system of FIG. 1 comprises a central processing Unit 10 in the form of a micro-computer to which data storage means 20,30 are coupled. In this case the data storage means comprise on the one hand a number of fixed magnetic disk units 20 which are both readable and writable, and on the other a number of optical readers 30 in which exchangeable optical storage media such as CD-ROMs, DVDs can be accommodated. The DVD standard (Digital Versatile Disk) is preferably chosen here, due to the markedly higher storage capacity compared to for instance CD-ROM. Although in the figure the different units are drawn as separate units, a collective unit, a so-called jukebox, can also be applied in practice for this purpose, in which a number of media can be placed simultaneously which can then all be approached selectively.

The information system moreover comprises a user interface presented via a display 40. The display here comprises an LCD touch screen and serves not only for the presentation of data but also as input means for the user. If desired, a normal display can however also be used to which is added a keyboard optionally in combination with a mouse or track-ball.

In order to match supply and demand on a labour market a company impression of all contracted or otherwise selected employers is produced on the demand side. Taken for instance as starting point for this purpose is company information which is possibly already available, preferably information provided with film images and sound fragments in order to liven up the whole. This information is supplemented with strictly static and textual information such as (recent) news items relating to the company in question and data derived from one or more annual reports or quarterly figures. Although in the present application an enterprise which may or may not be quoted on the stock market is usually used as potential employer, it should be noted that the invention is also suitable for recruitment of personnel for governments or institutions and the like, which are therefore also designated as company within the scope of the present invention. Instead of an annual report, other available annual figures can be used in this latter case to give an impression of the financial scale and state of the company. According to the invention a cultural impression is moreover added to the company presentation. For this purpose interviews are conducted with staff members of different departments within the company. A choice is made per se for at least one comparatively recently hired trainee, one or more staff members who have already been employed for a number of years, and an interview with the chairman of the board of directors or the general managing-director. The interviewed staff members can furthermore be chosen here from different departments of the company. An interview with a recruiter from a personnel department can optionally be added. These interviews are recorded on film or video and together aim to give an impression of the corporate culture or the corporate cultures within the company or institution. In addition to filmed interviews, other film images can also be made of the company in order to convey a cultural impression. Both the text information and the audio and video fragments are combined into a multimedia presentation of the company and stored as such on data storage means 20,30. This is done in respect of all companies, institutions and governments included in the information system. The different corporate presentations herein preferably have an at least predominantly uniform design. Not only does this result in more cohesion between the presentations themselves, it also enhances the accessibility of the information incorporated therein.

System 10-40 is accommodated in a joint housing which is preferably given an attractive appearance. An embodiment of a suitable housing in shown in FIG. 4. This is a column-like whole comprising a hollow column 60 in which are accommodated the central processing unit and data storage means to which touch screen 40 is coupled. This whole is placed in an optionally publically accessible space which is known to be visited by many aspiring employees. Envisaged as such can be a hall, corridor, auditorium or other space within a university, college or other educational institution where the target group receives education. The stylistic character of the housing will immediately attract attention and entice people to make use thereof.

Via touch screen 40 the user has access to all presentations stored in the system and can thus consult the ‘hard’ factual information relating to the companies in which he or she is interested as well as gain an impression of the corporate culture prevalent there. By providing search mechanisms via the user interface, for instance based on school education and subjects chosen or course of study of the candidate and profile information of the companies, a targeted selection can be made of the companies having a profile matching the entered user profile. The system thus immediately creates ‘awareness’ in the candidate in respect of the selected companies. The candidate can now consult the stored multimedia presentation of the companies and institutions in question via the user interface, so that ‘consideration’ regarding one or more of these companies can be created in his candidate. Furthermore, owing to the cultural impression provided therein according to the invention, the candidate can at the same time sample the corporate culture and either feel an affiliation therewith or not. If the corporate culture appeals to the candidate, this will soon lead to ‘preference’ , or a feeling of wanting to belong, which will cause the user to continue with a job application to the company of his or her preference.

The whole system can be applied per se in stand-alone manner as shown in FIG. 1. If desired, only hard disk units or exchangeable media such as CD-ROM and DVD can herein be applied instead of the combination used as point of departure in the described embodiment. However, the combination of both types of media produces a surprising bonus effect in that the part of the presentation that is little subject to change, such as for instance a recorded interview and annual report data, are stored on CD-ROM or DVD and can be retrieved from this medium, while more variable data is stored on a hard disk unit and can hereby be refreshed, supplemented or, if desired, removed at all times. The exchangeable media such as a CD-ROM and DVD can be manufactured in large numbers relatively cheaply and then be distributed among all operational systems, The remaining information is either written locally from an exchangeable medium onto the hard disk or can be managed remotely. With a view to the latter, a second embodiment of the system according to the invention as shown in FIG. 2 provides a communication interface to which central processing unit 10 is coupled. In the system of FIG. 2 the communication interface comprises a modem or ISDN interface 51 with which a connection 50 can be maintained to a corresponding interface 52 of a remote computer system 60 via the public telephone network. The data stored on data storage means 20-30 can be accessed from this computer system 60 and the data on hard disk units 20 can be refreshed and updated remotely as desired Central maintenance and management is thus possible of all information systems according to the invention thus equipped with telecommunication facilities. Instead of an ISDN or analog telephone connection, it is also possible to resort to a broadband data connection as provided by ADSL and many cable networks, whereby the remote management options even increase.

A third embodiment of an information system according to the invention is shown in FIG. 3. The central processing unit and at least a part of the data storage means are herein coupled in a network 70. The central processing unit functions in this case as network server and provides a number of network stations 80 with access to the stored data via the network. The network can herein comprise any form of LAN (local area network) or WAN (wide area network), but is particularly formed, as in this embodiment, by the Internet. The central processing unit herein forms a web server so that the stored information can be accessed on work stations 80 by means of conventional Internet browsers. A prospective employee can hereby fully utilize the information system according to the invention from his or her own workplace. The work station thus forms the user interface of the system which is situated elsewhere. In view of the relatively large amount of data usually involved in a multimedia presentation, a broadband connection with network 70 is to be strongly recommended here. The system herein also provides the option of electronic message traffic, for instance on the basis of Internet e-mail, so that the candidate can, if desired, communicate directly or indirectly with the company of his or her choice. If desired, a video message from the candidate can be added thereto.

An information system according to the invention can thus be implemented in different ways without the description being exhaustive in this respect. On the contrary, many more embodiments and variations are possible for a person of ordinary skill in the art within the scope of the invention.

1. Information system for matching supply and demand on a labour market, comprising data storage means for storing thereon in electronic form information relating to potential employers, a user interface enabling users to consult the stored information and a central processing unit for providing the stored information via the user interface, wherein the information offers a multimedia presentation in respect of at least some of the employers, comprising both text information and film images.

2. Information system as claimed in claim 1, characterized in that the multimedia presentation comprises components from a group of an optionally filmed general company impression, an interview with or speech by a member of the board of directors, an interview with staff members of one or more different departments and levels of experience, at least outlines of at least one annual report, general company information and news reports.

3. Information system as claimed in claim 1 or 2, characterized in that the data storage means are accommodated in a joint housing at least partly together with the central processing unit and the user interface.

4. Information system as claimed in claim 1, 2 or 3, characterized in that the user interface comprises a touch screen and that the central processing unit, loaded with a suitable program code, offers via the touch screen an interactive interface which provides access to the stored information.

5. Information system as claimed in one or more of the foregoing claims, characterized in that the data storage means comprise at least one exchangeable information carrier.

6. Information system as claimed in one or more of the foregoing claims, characterized in that the data storage means comprise at least one local memory unit, in particular a hard drive station, which is writable and readable by electronic means.

7. Information system as claimed in one or more of the foregoing claims, characterized in that the central processing unit is coupled to a communication interface for communication with at least one remote computer system.

8. Information system as claimed in claim 7, characterized in that the at least one remote computer system comprises at least a part of the data storage means.

9. Information system as claimed in claim 7 or 8, characterized in that the information system and the at least one remote computer system are mutually coupled in an information network.

10. Information system as claimed in claim 9, characterized in that the information network forms part of the Internet.

11. Information system as claimed in one or more of the foregoing claims, characterized in that communication means are provided which enable a user to make contact with an employer of choice.

12. Information system as claimed in claim 11, characterized in that the communication means comprise provisions for electronic message traffic.

13. Information system as claimed in claim 11 or 12, characterized in that the communication means comprise provisions for transmitting a video message.

14. Method for matching supply and demand on a labour market, wherein information relating to the company of one or more employers is presented to one or more potential employees, characterized in that a multimedia presentation is produced of the company of a number of employers, that the produced presentations are stored on data storage means and that potential employees are provided with access to the presentations stored on the data storage means via an interactive user interface.

15. Method as claimed in claim 14, characterized in that the multimedia presentations of the companies of the employers have an at least predominantly uniform design.

16. Method as claimed in claim 15, characterized in that a general company impression is compiled, and an interview is recorded with a member of the board of directors, and with members of staff of one or more different departments and levels of experience within the company, and that the recordings and company impression are brought together in the multimedia presentation of the company.

17. Method as claimed in claim 16, characterized in that at least outlines of at least one annual report, optionally in combination with general company information and news reports, are added to the multimedia presentation

18. Method as claimed in one or more of the claims 14-17, characterized in that the data storage means are accommodated in a joint housing at least partly together with the user interface and that the housing is placed in a space which is regularly visited by potential employees.
